(19) United States
(12) Patent Application Publication
(10) Pub. No.: US 2026/0267632 A1
(43) Pub. Date: Sep. 10, 2026

(54) DEBUGGING TECHNIQUES USING REASONING PATH ANALYSIS

(71) Applicant: SAP SE, Walldorf (DE)

(72) Inventors: Jingun Hong, Bundang-gu (KR); Ji Young Kim, Seoul (KR); Sewon Kim, Seoul (KR)

(73) Assignee: SAP SE, Walldorf (DE)

(21) Appl. No.: 19/071,599

(22) Filed: Mar. 5, 2025

(51) Int. Cl. G06F 8/65; G06F 8/73; G06F 11/362

(52) U.S. Cl. CPC G06F 8/65; G06F 8/73; G06F 11/362

(57) ABSTRACT

Techniques are disclosed for extracting and applying structured debugging knowledge to resolve software bugs. A computing system processes electronic representations of software bug reports, including comments describing reasoning processes for debugging. A first neural language model extracts structured reasoning paths from the reports, which are used to fine-tune a second neural language model. When a new bug is encountered, the second model generates suggested actions or deploys a fix. Alternatively, structured reasoning paths are embedded into a vector database, enabling similarity searches against new bug descriptions. Retrieved reasoning paths are submitted to a neural language model to generate debugging recommendations or automated fixes. A hierarchical structure preserves relationships between reasoning paths, facilitating reasoning path retrieval and refinement. The system supports tree reconstruction, relational database storage, and hierarchical summarization of debugging knowledge to improve software maintenance and reduce resolution time.

### FIELD

This disclosure relates generally to software debugging and maintenance. More specifically, it pertains to the extraction, processing, storage, or application of debugging knowledge for resolving software bugs, including but not limited to, reasoning path analysis, retrieval-based workflows, and automated code modification.

### BACKGROUND

Software programs can be exceedingly complex. In particular, enterprise level software applications can provide a wide range of functionality, and can process huge amounts of data, including in different formats, such as structured, semi-structured, or unstructured data, where data schemas for such data can also vary significantly. Software is typically tested to varying degrees prior to making software available for productive use. Further testing can be performed as part of software updates or software maintenance.

Despite this testing, software bugs or unexpected software behavior can still occur once software is “released.” In some cases, software bugs may not be apparent until particular data is processed by the software, until multiple features are used together in a particular way, or until a particular set of operational conditions occurs.

It is desirable to identify software bugs or performance issues as quickly as possible, as well as to start and complete a process to resolve such bugs or issues. This is particularly important for software that supports the day-to-day activities of business enterprises, among others, as downtime can cause serious issues. Often, a software company is responsible for addressing software issues that might occur during customer use, and there may be contractual obligations regarding how quickly issues are to be identified and resolved.

Typically, software support engineers are responsible for becoming aware of an incident and indicating incident resolution, which can include creating an incident record and obtaining and analyzing information relating to the issue. This analysis can include reviewing data provided regarding the issue (such as error messages or logs, or performance information) and information provided, such as by a user/client, regarding the issue or comments made by other support personnel who may be involved in resolving the incident. The software support engineer determines how to address the issue, implements the resolution, and then closes the incident record. Various reports, such as incident resolution reports or performance metrics, may be generated to document a software company's performance in identifying and resolving issues in a timely manner.

Even for experienced software support engineers, it can be difficult and time consuming to identify a root cause of a bug and develop a solution, such as a software patch, to address the bug. For less experienced software support engineers the issue can be even more acute because they have less of a knowledge base to draw on. While records may exist documenting prior bug fixes, including those the show reasoning that could be used to address a current bug, it is impractical for engineers to review these records, particularly in a manner that allows for prompt resolution of a newly observed bug. Similarly, the reasoning or insights needed to address a newly observed bug may not exist in a single bug report, but rather may be determined only after reviewing reports for multiple bugs, where, for example, common problem-solving techniques may have been used, but not readily apparent from reviewing the collection of reports. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques are disclosed for extracting and applying structured debugging knowledge to resolve software bugs. A computing system processes electronic representations of software bug reports, including comments describing reasoning processes for debugging. A first neural language model extracts structured reasoning paths from the reports, which are used to fine-tune a second neural language model. When a new bug is encountered, the second model generates suggested actions or generates deploys a fix, such as a code patch to be applied to the code with the software bug. Alternatively, structured reasoning paths are embedded into a vector database, enabling similarity searches against new bug descriptions. Retrieved reasoning paths are submitted to a neural language model to generate debugging recommendations or automated fixes. A hierarchical structure preserves relationships between reasoning paths, facilitating reasoning path retrieval and refinement. The system supports tree reconstruction, relational database storage, and hierarchical summarization of debugging knowledge to improve software maintenance and reduce resolution time. This

In one aspect, the present disclosure provides a process for generating debugging solutions using a neural language model. Electronic representations of information describing a set of software bugs are received. This information includes comments that document the reasoning process used to develop solutions for respective bugs based on their corresponding descriptions. A first prompt is submitted to a first neural language model to extract structured reasoning paths from the received information.

Once processed, the structured reasoning paths are received from the first neural language model. A second neural language model is fine-tuned using the extracted structured reasoning paths. The second neural language model may be the same as or different from the first neural language model.

An electronic representation of a description of symptoms for a current software bug is received. A second prompt is submitted to the second neural language model, requesting suggested actions to address the current software bug.

The second neural language model generates suggestions, which are received. The suggested actions are either displayed to a user or automatically executed to address the current software bug, depending on the implementation.

In another aspect, the present disclosure provides a process for identifying and applying debugging solutions using a neural language model and a vector database. Electronic representations of information describing a set of software bugs are received. This information includes respective comments detailing reasoning processes used to develop solutions for the corresponding bugs.

A first prompt is submitted to a first neural language model, extracting structured reasoning paths from the received information. The structured reasoning paths are received from the first neural language model. First embeddings are generated for the extracted structured reasoning paths. The generated embeddings are stored in a vector database.

An electronic representation of a description of symptoms for a current software bug is received. A second embedding is generated for the description of symptoms of the current software bug. A similarity search is performed within the vector database using the second embedding to identify one or more similar embeddings.

At least one structured reasoning path is generated. The structured reasoning path is submitted to a second neural language model in a prompt that includes an instruction to generate suggested actions to address the current software bug. The second neural language model may be the same as or different from the first neural language model. The neural language model either provides suggested actions for addressing the current software bug or automatically executes one or more actions to resolve the issue based on the suggested actions.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1 illustrates an example bug report, such as produced by BUGZILLA, which includes structured data fields and serves as a basis for debugging workflows.

FIG. 2 illustrates example unstructured comments associated with a bug report, which provide insights into debugging processes and can be processed into reasoning paths.

FIG. 3A illustrates an XML representation of a bug report, combining structured and unstructured data into a machine-readable format.

FIG. 3B illustrates additional XML elements that capture debugging context, including developer comments and reasoning paths.

FIG. 4 illustrates a set of reasoning paths extracted from a bug report, organized into observations, thoughts, actions, and evaluations.

FIG. 5A illustrates the relationship between base reasoning paths and generalized reasoning paths, showing how specific debugging insights can be abstracted for broader applicability.

FIG. 5B illustrates a nested and recursive structure for reasoning paths, showing how observations, thoughts, actions, and evaluations are hierarchically linked to capture the iterative debugging process.

FIG. 6A illustrates the process of ingesting, pre-processing, and structuring bug report data to facilitate reasoning path extraction.

FIG. 6B illustrates the organization of extracted reasoning paths into a hierarchical tree structure, including details stored at each node.

FIG. 6C illustrates the retrieval and reconstruction of reasoning paths tailored to a new bug symptom, including similarity search and tree reconstruction processes.

FIG. 7 illustrates a workflow where a fine-tuned neural language model is used to extract reasoning paths from historical bug reports and predict actions for new bug symptoms.

FIG. 8 illustrates a process for processing bug reports, extracting reasoning paths, and retrieving relevant paths for new bug symptoms, including tree reconstruction.

FIG. 9 illustrates the construction of a RAPTOR tree, including hierarchical clustering and summarization processes, and details the contents of individual nodes in the tree.

FIG. 10 illustrates the use of a RAPTOR tree for retrieving relevant debugging context and combining it with a query to generate solutions, including tree traversal and collapsed tree retrieval methods.

FIG. 11A illustrates an example of before-code, representing the state of the code prior to applying a debugging fix.

FIG. 11B illustrates an example of after-code, representing the state of the code after applying a debugging fix.

FIG. 12A is a flowchart of a process of generating debugging solutions using a neural language model.

FIG. 12B is a flowchart of a process of identifying and applying debugging solutions using a neural language model and a vector database.

FIG. 13 is a diagram of an example computing system in which the described embodiments can be implemented.

FIG. 14 is an example cloud computing environment that can be used in conjunction with the technologies described herein.

### DETAILED DESCRIPTION

### Example 1—Overview of Debugging and Reasoning Path Analysis

Continuing from the Background, the present disclosure provides techniques and solutions that address challenges associated with bug tracking and resolution processes. These challenges include the difficulty of extracting actionable insights from unstructured developer comments, the inefficiency of manual debugging workflows, and the limited reusability of historical bug resolution data for new, related issues. Specifically, various types of reports documenting debugging efforts can be analyzed and processed to generate suggestions for addressing newly encountered bugs. In some implementations, these techniques extend beyond generating debugging recommendations to automatically generating code, such as a patch, to address specific bugs. These patches may be presented to a user for approval before deployment or automatically applied to the software if defined validation criteria are satisfied.

In one implementation, information from bug tracking systems, such as BUGZILLA (Zarro Boogs Corporation), is parsed into distinct components: observations, thoughts, actions, and evaluations. Observations refer to the initial descriptions of problems or symptoms, including details such as error messages or unexpected behaviors reported by users or developers. Thoughts represent the hypotheses or analyses formulated by developers regarding the potential causes of the issue. Actions document the specific steps taken to address the issue, such as code modifications, configuration adjustments, or other corrective measures. Evaluations indicate the outcomes of these actions, describing whether they resolved the issue, partially addressed it, or failed to produce any effect. Together, these components form structured reasoning paths that can be analyzed to improve bug resolution processes using a structured debugging methodology.

A neural language model processes structured or unstructured text data from bug tracking systems to produce structured reasoning paths in the form of observations, thoughts, actions, and evaluations (also referred to as “OTAE”). Optionally, the structured or unstructured text is pre-processed to remove noise, such as timestamps and irrelevant system messages, and then fine-tuned neural language models, such as transformer models, are used to classify and extract relevant components. The neural language model distinguishes between causal relationships, developer intentions, and outcomes, accurately parsing reasoning paths.

In a particular implementation, these outputs are encoded into semantic embeddings, which are mathematical representations of the structured data in a vector space optimized for similarity-based retrieval. Embedding generation is performed using techniques such as Sentence Transformers, which map textual data into high-dimensional spaces where semantically similar content is clustered together. This approach facilitates efficient and accurate similarity searches, even across large datasets of historical bug resolution data.

When a new bug is encountered, its description is also converted into a semantic embedding. A similarity search algorithm, often based on Approximate Nearest Neighbors (ANN) techniques, retrieves the most relevant embeddings from the vector database by comparing the new bug's embedding to stored embeddings. This allows for rapid identification of relevant historical cases, even in high-dimensional spaces, by leveraging optimized indexing structures such as HNSW graphs or KD-trees.

A similarity search can then be conducted in a repository, such as a vector database, containing embeddings of historical bug resolution data. This search identifies reasoning paths most relevant to the newly encountered bug. The associated data retrieved through this process can include textual descriptions of observations, thoughts, actions, and evaluations, as well as additional information such as original bug reports or code generated during previous bug resolution efforts.

The disclosed techniques can use large language models, but more generally can be implemented using other types of neural language models, optionally integrated with natural language generation capabilities. Neural language models are computational frameworks for processing, generating, or interpreting natural language using architectures based on neural networks. These models are typically trained on large-scale corpora that include technical documentation, bug reports, and developer discussions. During training, techniques such as masked language modeling or autoregressive modeling can be used to optimize the model's ability to predict and generate coherent language. Fine-tuning on domain-specific datasets, such as bug resolution histories, enhances the model's performance in specialized tasks. These models learn language representations through training on extensive datasets and are capable of identifying patterns, relationships, and contextual nuances in sequences of words or tokens.

Examples of neural language models include recurrent neural networks, long short-term memory networks, and transformer-based models. Transformer models, which include both small language models and large language models, use self-attention mechanisms to process complex language structures. Architectures employing techniques such as the Mixture of Experts paradigm are also within the scope of the present disclosure.

Structured reasoning paths retrieved from the vector database can be further processed by a neural language model to produce actionable outputs. In some implementations, the model analyzes the retrieved reasoning paths and suggests specific actions that a software support engineer can take to address the bug. For instance, the model may recommend adjustments to configuration settings or propose targeted diagnostic tests. Other implementations involve the model generating proposed code changes, such as a code patch, to address the bug based on the structured reasoning path and historical debugging data. These outputs are presented to the software support engineer, who can evaluate them for their suitability and potential side effects before implementation. This approach allows for leveraging historical bug resolution data to improve the efficiency and effectiveness of debugging processes, while preserving human oversight for decision-making steps, such as changing a codebase. In other scenarios, changes, such as code patches, can be automatically applied, including if specified automated validation criteria are satisfied.

### Example 2—Processing Bug Reports and Extracting Reasoning Paths

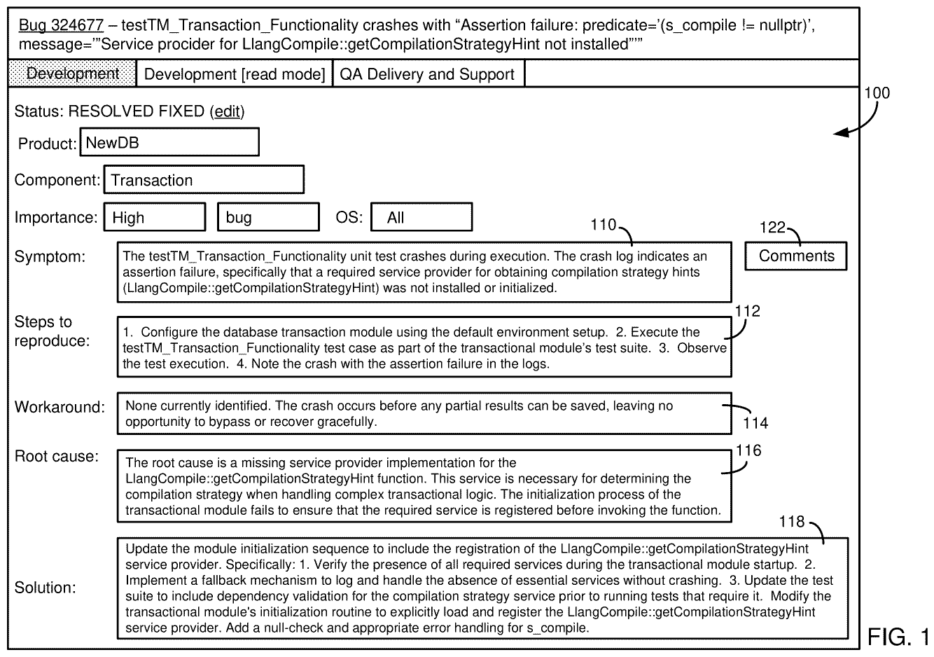

FIG. 1 illustrates an example bug report 100, such as one produced by BUGZILLA. The bug report 100 includes multiple text fields, with each field representing structured data describing various aspects of the bug. Among the structured data, text 110 provides a description of the nature of the bug, detailing symptoms or unexpected behaviors observed by users or developers. Text 112 specifies how the bug can be reproduced, which is used for confirming its existence and understanding its context. Text 114 documents any workarounds that might mitigate the bug temporarily while a permanent fix is identified. Text 116 identifies the root cause of the bug, such as a specific defect in code or configuration. Finally, text 118 describes the solution that resolves the bug, such as a solution that includes specific steps, code changes, or configuration updates.

The example bug report 100 reflects a resolved bug, where all fields have been completed. However, in practice, the process of populating the bug report 100 often occurs in stages. Typically, the initial information, such as text 110 describing the bug, is provided first. This information may originate from an end user or client of the software vendor, reporting observed symptoms or issues. At this stage, the exact cause of the bug may not be known. A software support engineer then begins investigating whether the bug can be reliably reproduced and identifies the circumstances under which it occurs, updating text 112 as the investigation progresses. Over time, additional details—including workarounds, root cause analyses, and final resolutions—are documented in the fields corresponding to text 114, 116, and 118, respectively.

While the structured elements of the bug report 100 provide important information, significantly more data is often generated during the resolution process. For instance, software support engineers may leave detailed comments documenting their troubleshooting efforts, experiments, and intermediate findings. These comments are frequently unstructured and may capture valuable insights that are not directly recorded in the structured fields. In many cases, resolving a bug involves collaboration among a team of individuals, such as software support engineers and quality assurance testers. These collaborative efforts generate additional context that may be invaluable for understanding the problem and its resolution.

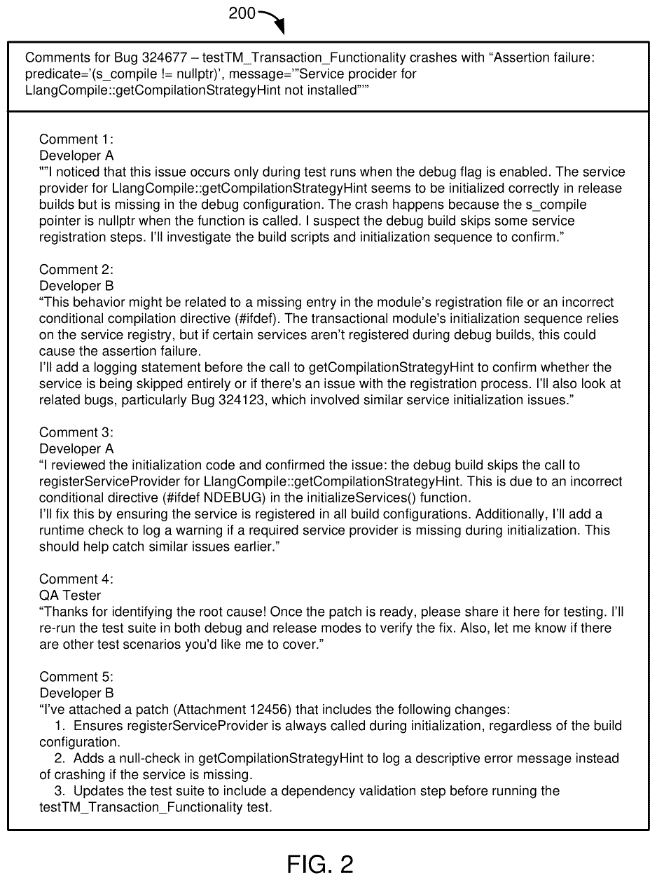

The bug report 100 may include a user interface element 122, which provides access to the unstructured comments associated with the bug report. FIG. 2 illustrates an example set of comments 200 that can be viewed by selecting the user interface element 122. These comments often provide deeper insights into the process of resolving the bug, such as detailed explanations of hypotheses tested, actions taken, and results observed. The unstructured comments may also include references to related bugs, past resolutions, or external resources consulted during the debugging process.

The comments 200 can be analyzed to generate structured information corresponding to observations, thoughts, actions, and evaluations (OTAE), where a set of OTAE information can be referred to as a reasoning path, or simply just a path. As described above, observations refer to the initial problem description or symptoms identified in the bug report or comments. For example, error messages or descriptions of unexpected behaviors may constitute observations.

Thoughts represent the hypotheses or analyses made by developers as they attempt to diagnose the issue. These thoughts often include potential causes and possible avenues for investigation.

Actions are the specific steps taken to address the bug, such as modifying a function, adjusting configuration files, or performing tests. Evaluations document the outcomes of these actions, indicating whether they resolved the issue, partially addressed it, or were ineffective.

A single bug report may include one or multiple reasoning paths, depending on the complexity of the issue and the number of attempts required to resolve it. Disclosed techniques support the use of multi-level reasoning paths, where individual reasoning paths form nodes in a hierarchical structure. For example, a multi-level reasoning path might trace the progression from initial observations to intermediate findings and eventually to the resolution of the bug. This hierarchical structure captures the iterative nature of debugging, allowing for a detailed representation of the process.

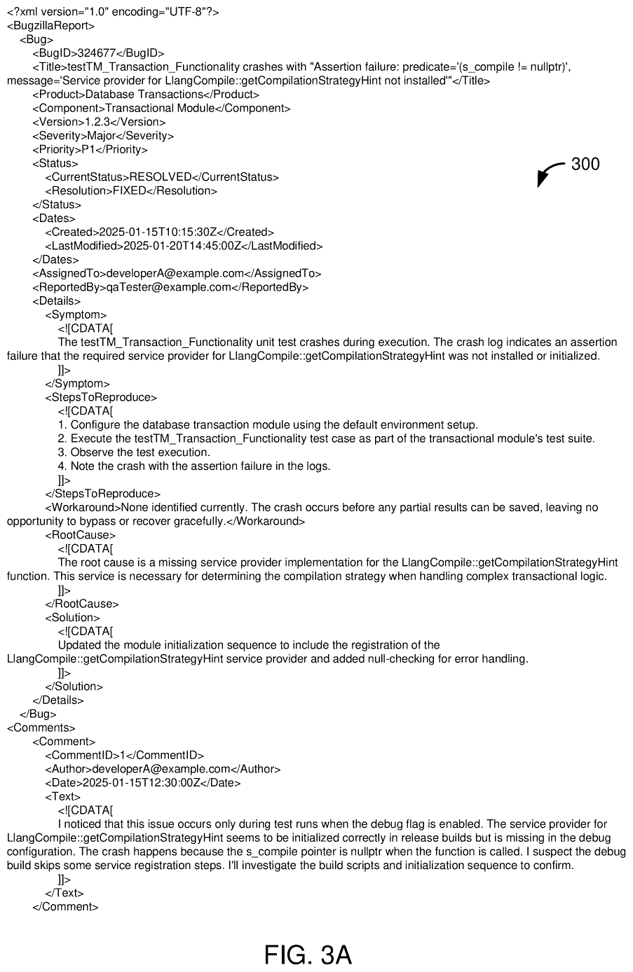

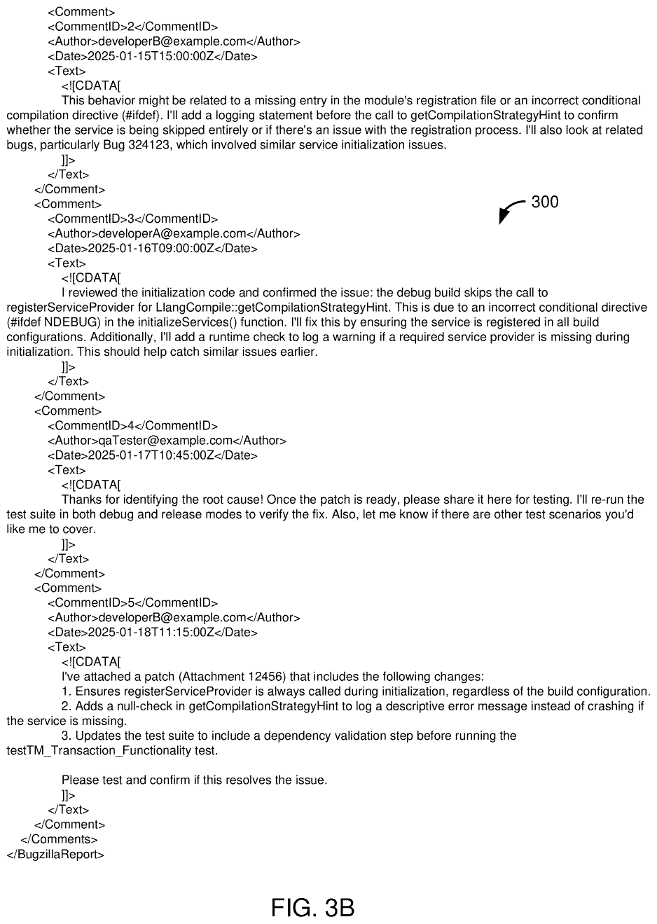

The unstructured comments 200, as well as other elements of the bug report 100, can be converted into structured data using an XML-based representation 300, as illustrated in FIGS. 3A and 3B. This conversion process involves parsing and organizing both structured and unstructured data into a format suitable for further analysis, including neural language models. The XML format provides a standardized way to represent aspects of a bug report, including metadata, developer comments, and the debugging process. Structured formats such as XML, YAML, JSON, and Markdown are known to improve the ability of large language models to process and understand documents by providing explicit structure and organization. These formats define relationships between different elements of the document, making it easier for the model to parse key components, extract relevant details, and maintain context. By enforcing a consistent format, structured representations reduce ambiguity in natural language processing, improving the accuracy of reasoning path extraction and subsequent predictions.

In the example shown in FIG. 3, the XML representation captures a detailed snapshot of the bug's lifecycle. The structured fields, such as the bug title, severity, priority, and dates, are directly mapped from the existing structured elements in the bug report 100. Meanwhile, the comments 200 are incorporated as nested elements within the XML, preserving their original content while adding metadata such as author, timestamp, and comment IDs. Additionally, the XML representation includes sections that document elements of the debugging process, such as the observed symptoms, steps to reproduce the bug, identified root causes, workarounds, and the applied solutions.

The structured format facilitates interoperability with a wide range of computational systems, facilitating integration with databases, vector repositories, and machine learning pipelines. The XML format provides a standardized schema for organizing complex bug data, ensuring that it can be readily accessed and analyzed by downstream processes.

The XML representation allows for the enrichment of the bug report with additional metadata and contextual information. For example, specific fields can be added to capture links between the bug report and its associated reasoning paths, encoding references to the OTAE information extracted from the comments. This linkage enhances traceability and allows reasoning paths to be associated with both structured fields and the unstructured commentary from which they were derived.

The XML format supports the inclusion of “before” and “after” code snippets for cases where code changes are part of the solution. This allows the neural language model to analyze historical examples of code patches, learning patterns that can inform the automatic generation of new patches for similar issues. By providing a complete view of the debugging process, including the code modifications, the XML representation provides a comprehensive dataset for training and inference.

The standardized representation supports scalability, enabling the processing of large datasets containing thousands or millions of bug reports. Automated tools can ingest the XML data to extract insights, identify recurring patterns, and generate recommendations for debugging workflows.

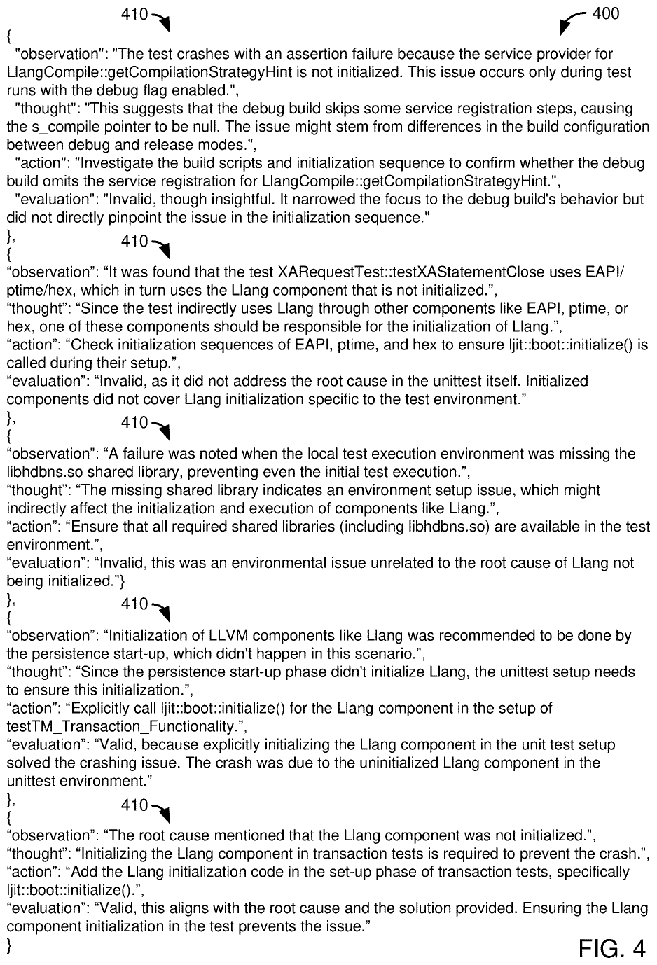

The XML representation 300 of FIGS. 3A and 3B can be used to generate a set 400 of reasoning paths 410, as illustrated in FIG. 4, that can be generated based on the comments 200 and, optionally, elements of the structured data in the bug report 100, including from an XML representation 300 of such information. Each reasoning path 410 includes an observation, a thought, an action, and an evaluation. These paths 410 do not necessarily correspond verbatim to the text in the comments. Instead, they represent the results of an analysis performed by a neural language model. By interpreting the comments and generalizing the information they contain, the neural language model generates OTAE information that provides information applicable to the resolved bug, and is also applicable to bugs that may later arise.

The ability to generalize reasoning paths is a significant advantage of the disclosed techniques. For example, while the comments for a resolved bug may reference specific components, functions, or configurations, the generated reasoning paths can abstract these details to create more broadly applicable insights. This generalization allows for reasoning patterns to be reused in resolving newly discovered bugs, even if those bugs involve different code bases or system components. By leveraging historical data in this manner, the disclosed techniques improve the efficiency and effectiveness of software debugging processes.

As example of a suitable prompt that can be provided to a neural language model to generate the set 400 of paths 410, or paths/OTAE information more generally is:

Extract and structure the reasoning paths from the provided crash issue discussion.

Each path must follow this hierarchical structure:
Observation: Initial symptom or issue
Reasoning Paths:
   *Thought: Analysis or hypothesis
   *Action: Specific corrective step (must include exact changes to code/configuration)
   Evaluation: Marked as “Valid”/“Invalid” with supporting reasoning
   New Observations: Findings that result directly from implementing the action above

Note:
Actions must be specific (e.g., “Modify function X to handle null values” rather than “Check the code”)
New observations should only branch if they reveal distinct issues
Merge redundant observations into existing paths
Each path should trace to root cause and solution
Avoid case-specific details (process numbers, line numbers, IDs)
Each new observation must be a direct result of its parent action

Output in this JSON format:

```
{
“new_observations”: [
    {
      “observation”: “”, “reasoning_paths”: [
          {
            “thought”: “”,
            “action”: “”,
            “evaluation”: “”,
              new_observations”: [ ]
          }
        ]
    }
  ]
}
```

The above prompt indicates that the neural language model can generate new observations. As discussed, some reasoning paths are generated directly by processing comments and correspond to OTAE information explicitly present in the comments. However, the reasoning capability of the neural language model allows it to synthesize new observations and associated reasoning paths by generalizing or extrapolating from the extracted data. These new observations can be linked to one or more base reasoning paths, which are reasoning paths directly extracted from the comments.

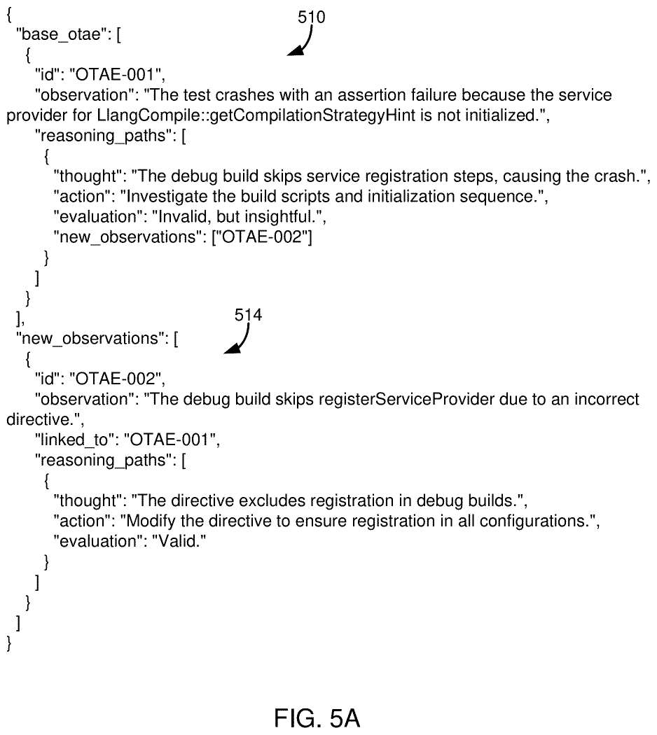

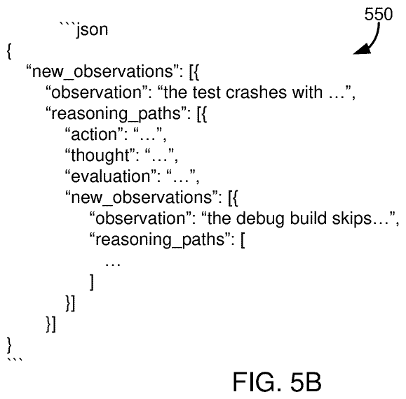

FIG. 5A illustrates a relationship between a base reasoning path 510 and a new observation associated with a new reasoning path 514. The base reasoning path 510 is focused on a specific failure cause and solution, such as the incorrect use of a conditional directive for a debug build. In contrast, the new reasoning path 514 generalizes the logic to recommend ensuring that registration operations are consistently applied across all build configurations. This generalization not only addresses the specific issue in the historical bug report, but also provides insights that can help prevent similar issues in other contexts, such as release builds or alternative configurations.

The ability to generate generalized reasoning paths and link them to specific base paths allows the neural language model to provide broader and more reusable insights. For example, while a base reasoning path might focus on debugging a service initialization failure due to a missing directive, the corresponding generalized reasoning path might abstract the recommendation to validate all critical service registrations during the build process. This capability increases the utility of the reasoning paths by making them applicable to a wider variety of bugs and system configurations.

Parent-child relationships between reasoning paths capture the logical progression of debugging steps, where each new observation generated by an action in a parent path serves as the basis for a child path. This hierarchy reflects the iterative nature of debugging and problem-solving, providing traceability and ensuring that each step can be understood in the context of its predecessors. For instance, an action to investigate build scripts for skipped service registrations might generate a new observation identifying a problematic conditional directive. This observation forms the root of a child reasoning path that outlines the steps required to address the issue, such as modifying the directive and validating the fix.

In the JSON representation of reasoning paths, parent-child relationships can be explicitly encoded using fields such as “parent_path_id” and “child_paths.” A base reasoning path can include a list of child paths that extend its logic or address new observations. Metadata can also indicate whether a reasoning path has been generalized, allowing systems to differentiate between specific and broadly applicable recommendations. For example, a generalized reasoning path might include metadata fields like “generalized”: true or “derived_from”: “OTAE-410,” linking it to its originating base path while advertising its broader scope.

This structured representation supports various processing requests. A debugging assistance system can retrieve parent-child paths linked to a specific bug or system component, focusing on targeted analysis without unnecessary information. A quality assurance system can use generalized reasoning paths to identify recurring patterns and recommend proactive measures, such as enhanced testing protocols or configuration audits, to prevent similar issues. For automated code generation, the system can traverse the hierarchical reasoning paths to understand root causes and the logical progression of actions, and the used to generate code that addresses the issue.

Generalized reasoning paths also enable the system to identify general principles from specific cases, which can inform cross-project debugging strategies. For example, while a specific reasoning path might address an issue with service registration in a particular module, the generalized path could recommend standardizing initialization procedures across all modules to ensure consistent behavior.

FIG. 5B illustrates an alternative representation of reasoning paths using a nested and recursive JSON structure 550. In this representation, each observation is directly linked to one or more reasoning paths, which may themselves contain new observations leading to additional nested reasoning paths. This approach captures the hierarchical and iterative nature of debugging while preserving the full sequence of observations, thoughts, actions, and evaluations in a structured format.

The reasoning path structure 550 begins with an initial observation, such as an error message or failure symptom, which serves as the root node. Each reasoning path associated with the observation includes an action taken to address the issue, a thought or hypothesis explaining the action, and an evaluation indicating the effectiveness of the action. If a new observation is generated as a result of the action, it is nested within the reasoning path, forming a recursive hierarchy. For example, a reasoning path addressing a test crash may lead to a new observation indicating that the debug build skips service registration, prompting further reasoning paths to resolve the underlying issue.

This recursive JSON structure allows for efficient storage and retrieval of reasoning paths in systems that support hierarchical data processing. Unlike explicitly linked parent-child relationships in relational models, this approach inherently maintains debugging history as a structured tree within a single document or dataset. Additionally, each reasoning path can be independently analyzed or processed, allowing debugging systems to extract relevant portions of the tree based on similarity searches, causal relationships, or hierarchical depth constraints.

The recursive structure 550 also enables dynamic query expansion, where a debugging system can iteratively retrieve related observations and actions based on contextual relevance. For example, if a developer submits a query describing a particular software failure, the system can traverse nested reasoning paths to retrieve both high-level summaries and detailed debugging steps that may be applicable to resolving the issue. By leveraging this structured format, debugging systems can provide enhanced reasoning traceability, improve automated recommendations, and support integration with large language models for predictive analysis.

### Example 3—Using Reasoning Paths for Similarity-based Retrieval

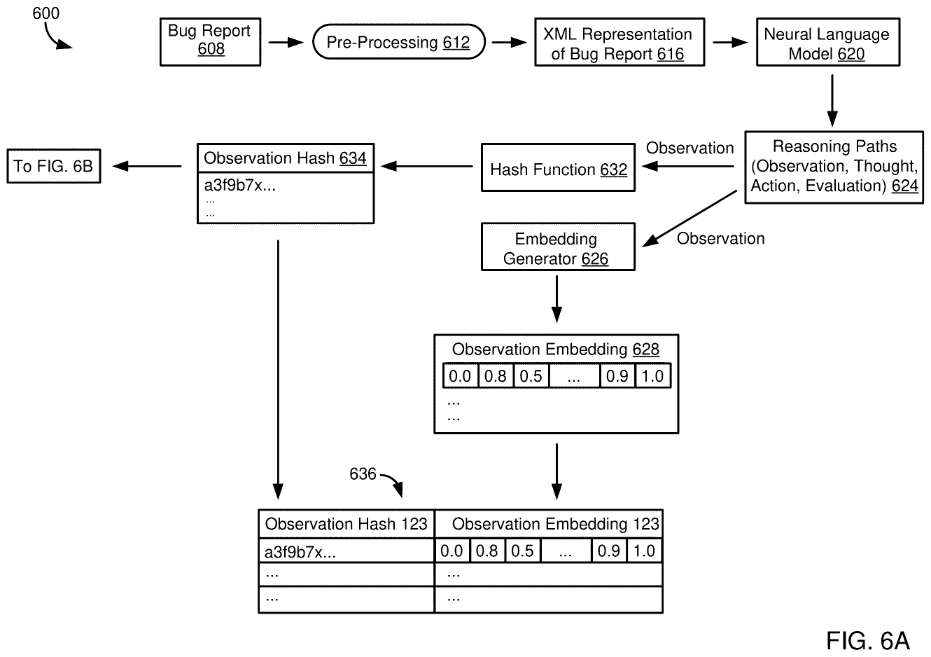

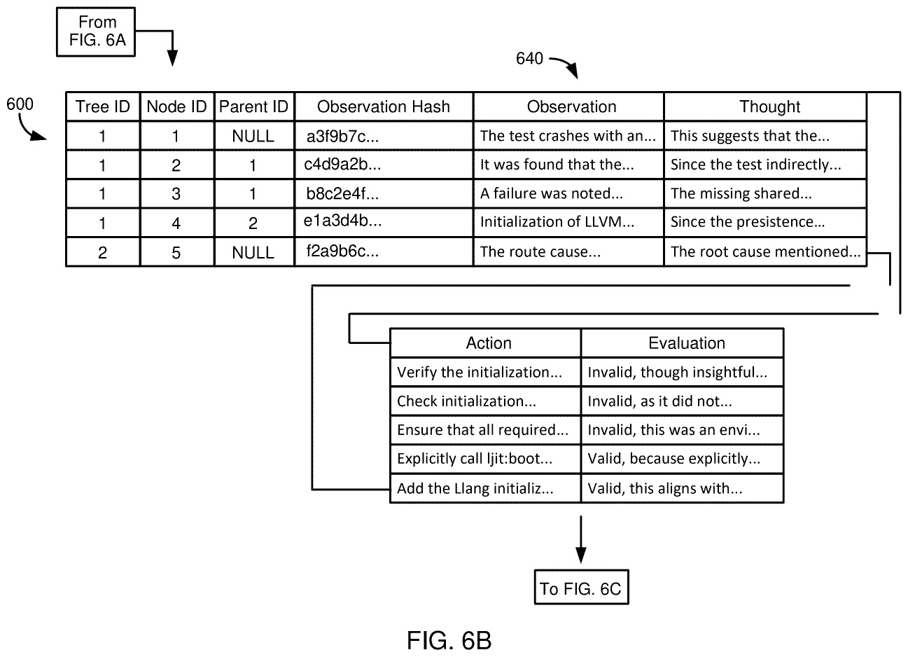

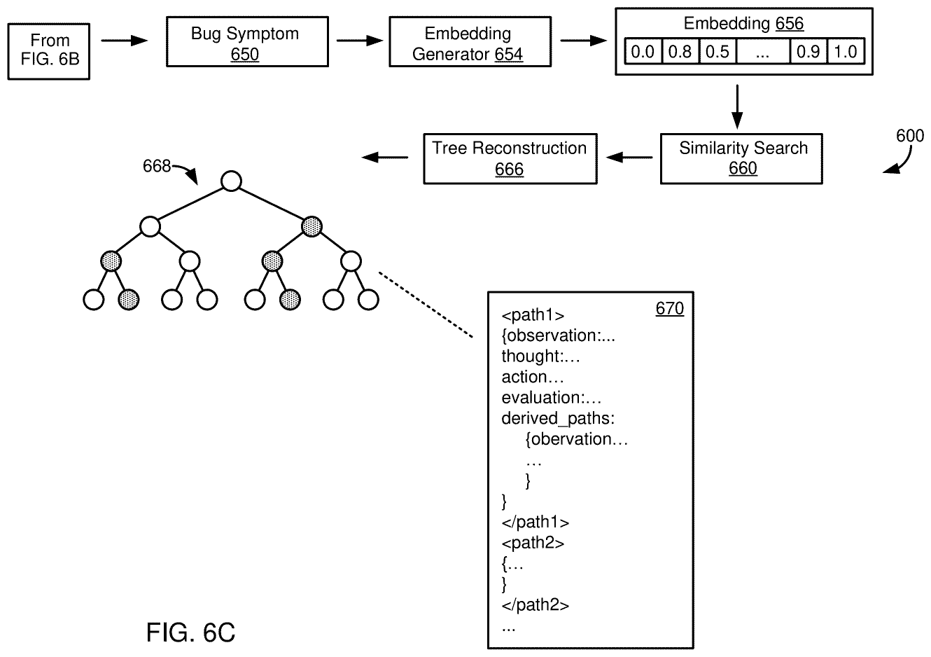

FIG. 6A-6C illustrates a process 600 for processing historical bug reports and using extracted information to assist in debugging efforts for a newly discovered bug. FIG. 6A illustrates the initial stage of the reasoning path extraction process, where raw bug report data is ingested and then pre-processed and transformed into structured formats suitable for analysis.

The process 600 begins with the collection of bug reports 608 and associated developer comments from repositories such as BUGZILLA. These inputs include structured metadata (e.g., bug ID, severity, and creation date), structured textual content, such as detailed descriptions of symptoms, reproduction steps, and root cause analyses, and structured or unstructured developer comments. To prepare the data for downstream analysis, it can be preprocessed at 612. Preprocessing can include operations such as removing noise, for example, timestamps, system logs, and irrelevant messages. Privacy compliance can be addressed by systematically redacting personally identifiable information. The resulting cleaned data maintains the chronological order of the debugging discussions, allowing the logical progression of reasoning paths to be accurately captured.

Once pre-processed, the data is converted into a standardized XML representation 616 that encapsulates both structured and unstructured information. This intermediate format organizes fields like symptoms, reproduction steps, and solutions alongside nested developer comments, creating a unified schema that facilitates programmatic analysis.

The standardized data is then processed by a neural language model 620 (such as an LLM), which extracts reasoning paths 624 structured into observations, thoughts, actions, and evaluations (OTAE). These structured elements are organized hierarchically to reflect the logical flow of the debugging process. For example, an extracted observation can describe the crash symptoms, while an associated action might suggest modifications to a specific function. Evaluations capture the outcomes of these actions, indicating whether they resolved the issue or provided insights for further investigation. The hierarchical structure allows for the representation of parent-child relationships, where each node in the reasoning path (which contains a set of OTAE information) can generate new observations, creating additional branches in the tree.

Semantic embeddings 628 of the reasoning paths 624 can be generated using an embedding generator 626. Semantic embeddings are vectorized representations of observations, created using machine learning models such as Sentence Transformers, BERT (Bidirectional Encoder Representations from Transformers), or OPENAI's embedding engines. These models encode textual data into high-dimensional vector spaces, capturing the semantic meaning of the text. For instance, an observation like “The test crashes due to missing service registration” is transformed into a numerical vector, where the proximity of this vector to others in the space reflects semantic similarity. Proximity in vector space reflects similarity in meaning, enabling efficient clustering of related debugging scenarios. Techniques such as fine-tuning pre-trained language models on domain-specific data, such as historical bug reports, enhance the embeddings'ability to capture relevant technical details.

To enhance retrieval efficiency, each reasoning path observation is assigned a unique observation hash 634 using a hash function 632, generated using algorithms such as MD5 or SHA-256. This hash 632 serves as a unique identifier for the observation, supporting fast indexing and retrieval. The observation hashes 632 and embeddings 626 are combined into a unified table 636. This table 636 includes entries for the hash, its corresponding semantic embedding, and metadata linking the observation to its reasoning path and hierarchical context.

The combined table 636 bridges the vector-based search layer and the relational storage system, enabling quick retrieval of reasoning paths once an embedding match is found. The combined table 636 also supports deduplication by allowing the system to identify and consolidate identical or semantically similar observations. This functionality allows redundant reasoning paths to be merged, reducing storage overhead and improving retrieval relevance.

The operations of the process 600 continue from the observation hash 634 in FIG. 6B. Note that the reasoning paths 624 and hash values 634 can be stored for later use, such as in a relational database. The embeddings 628 can also be stored for later use, such as in a vector database.

FIG. 6B illustrates the organization of reasoning paths into a hierarchical tree structure, maintained in a table 640, which organizes multiple trees, representing the logical progression of debugging steps and their relationships. Each node in a given tree corresponds to a specific step in the debugging process, such as an observation of a problem, a hypothesis about its cause, an action taken in response, or a result derived from the action. The tree structure allows the system to capture and represent the iterative nature of debugging, where each step builds on the outcomes of prior steps, forming a comprehensive pathway from the initial problem to the resolution.

In some implementations, each node in the table 640 includes a Tree_ID attribute, which distinguishes separate trees, and a Parent_Node_ID attribute, which is used to preserve tree structure information and define relationships between nodes. A root node is identified by checking whether its Parent_Node_ID is NULL or empty, indicating that it has no parent node in the tree structure. Each node is uniquely identified by a Node_ID, which must not be NULL or empty. Alternative approaches, such as adjacency lists or nested set models, may also be used to represent hierarchical relationships.

The root node of the tree represents the initial observation, which is typically the bug's symptom or failure mode as identified in the bug report. For example, the root might describe a test crashing due to a missing service registration or a null pointer dereference. Branches from the root represent different reasoning paths, each exploring a potential cause or solution for the issue. For instance, one branch might hypothesize that the problem lies in the initialization sequence, while another investigates external dependencies. These branches can further divide into sub-branches as new observations or results are generated, reflecting the exploratory and iterative approach developers use when debugging. Child nodes reference their corresponding Parent_Node_ID, allowing hierarchical relationships to be traversed efficiently in database queries.

The hierarchical structure of the tree serves multiple purposes. It enables the system to store and retrieve reasoning paths at various levels of detail, providing a complete view of the debugging process. A process for suggesting actions to address a similar bug might begin with a high-level overview of the tree, identifying the root cause and key actions taken, before analyzing specific branches to study detailed steps.

In addition to the tree structure, the table 640 stores detailed information for each node (representing a reasoning path, which is a set of OTAE information). The table 640 includes the observation hash and the text of each element of the OTAE information for a particular node. The observation hash acts as a unique identifier for each node, facilitating efficient indexing and retrieval. This structure allows reasoning paths to be organized based on both semantic relationships and hierarchical dependencies.

By including columns for reasoning path details, the table provides a compact and structured representation of the information associated with each node. This allows the system to separate the storage of reasoning path content from its hierarchical representation in the tree. Such separation simplifies operations like searching, updating, or merging nodes without altering the tree's structure.

The integration of the path information with the tree structure also supports functionalities like semantic search and reasoning path reconstruction. When a developer provides a new bug description, the system generates its semantic embedding and compares it to the embeddings stored in a vector database. Node information for matching embeddings can be used to retrieve textual descriptions of reasoning paths, and relationships between reasoning paths. The retrieval process can use Parent_Node_ID relationships to construct debugging workflows or suggest relevant steps based on similar historical resolutions.

FIG. 6C illustrates the process by which a bug symptom for a newly discovered bug is used to retrieve and reconstruct relevant reasoning paths, enabling developers to leverage historical debugging knowledge effectively. The portion of the process 600 of FIG. 6C begins with the receipt of a new bug symptom 650, which is converted into a semantic embedding 656 using a pre-trained or fine-tuned neural language model or embedding generator 654, such as the embedding generator 626. This embedding 656 represents the semantic meaning of the symptom in a high-dimensional vector space, enabling the process 600 to locate similar observations stored in its repository through a similarity search 660.

The similarity search 660 uses this embedding 656 to identify historical observations with the highest semantic similarity, such as based on the embeddings for those historical observations stored in a vector database. Techniques such as approximate nearest neighbor (ANN) searches using HNSW graphs or KD-trees are commonly used for semantic searches, other techniques, such as cosine similarity, can also be used. Cosine similarity measures the angle between two vectors in the vector space, providing a straightforward way to determine semantic similarity. Depending on system capabilities, the similarity search may be performed using separate vector storage or an integrated system that supports both vector search and relational queries.

Once the similarity search 660 is complete, the system identifies “hit” nodes within the reasoning path tree. Hit nodes are the tree nodes corresponding to observations that match the new symptom based on the similarity search. In implementations where the reasoning path is not natively stored as a hierarchical structure, the process 600 performs a tree reconstruction operation 666 for relevant portions of the tree around these hit nodes to produce a tree 668. This reconstruction can be governed by parameters specifying minimum or maximum levels of indirection for parent and child nodes of a hit node include, where the expansion to related nodes helps capture the context and subsequent steps associated with the matches. In some cases, tree reconstruction is not solely based on depth or hit status. The inclusion of non-hit, but related, nodes can depend on their connections to hit nodes and their relevance to the debugging process. For example, parent or child nodes may only be included if their embeddings are sufficiently similar to the embedding of the new bug or of the hit node, although the level of similarity can be lower than that used to identify hit nodes. In implementations where the relational database supports hierarchical functions, such as retrieving ancestor and descendant nodes, tree reconstruction may not be necessary. For example, SAP HANA supports both vector database operations and hierarchical queries, enabling retrieval of reasoning paths without explicit tree reconstruction.

Nodes that are directly connected to a hit node, either as parents or children, are typically included in the reconstructed tree. In some cases, child nodes at the same depth may have different inclusion criteria. For example, if one child node represents a reasoning path that was further explored in the debugging process, while another represents an abandoned path with no actionable steps or insights, the former would be included in the reconstructed tree, while the latter might be excluded. This allows the reconstructed tree to reflect relevant and useful reasoning paths, minimizing noise and unnecessary complexity. In systems where hierarchical queries are natively supported, filtering operations may be applied directly to the persistent storage layer rather than performing explicit tree reconstruction.

The reconstructed tree provides a tailored view of the debugging process, where each node retains its associated reasoning path information, including observations, thoughts, actions, and evaluations. To generate a JSON representation 670 of these reasoning paths, which can facilitate downstream use by a neural language mode, the process 600 can retrieve the OTAE information from the relational database, such as from the table 640 of FIG. 6B, and the table 636 of FIG. 6A, using the observation hashes as keys. The observation hash, which links the semantic embedding to the structured reasoning path data, serves as a bridge between the vector database and the relational storage layer. The process 600 first uses the observation hash to retrieve the matching vector and its associated node in the tree using the table 636. It then queries the table 640 to extract the detailed OTAE information for that node, ensuring that all relevant data is included in the JSON output.

An XML representation 670 encodes the reconstructed tree in a hierarchical format, where each node is represented as an object containing its OTAE fields, relationships to parent and child nodes, and additional metadata, such as evaluation results. For example, a node representing an action might include details about the specific code change or configuration adjustment performed, along with the evaluation indicating whether the action resolved the issue. Parent-child relationships are explicitly defined within the XML representation 670, capturing the logical flow of the debugging process. Although XML is provided as an example, the representation can be in another structured or semi-structured format, such as JSON.

The XML representation 670 of the reconstructed reasoning path tree provides a machine-readable structure that a neural language model can use to deliver tailored guidance to developers. The XML format preserves the hierarchical relationships between nodes, so the logical flow of the debugging process is accessible to the neural language model. Each node in the XML includes observations, thoughts, actions, and evaluations (OTAE) alongside metadata such as evaluation results and parent-child relationships. This detailed structure enables the neural language model to contextualize its analysis and provide actionable insights.

When the XML representation 670 is input into the neural language model, the model processes the OTAE information to generate specific, step-by-step recommendations. For example, the neural language model can analyze the observations and root causes in the reasoning paths to hypothesize about the underlying issue. Based on the actions and evaluations in the reasoning paths, the neural language model suggests corrective steps tailored to the new bug's context. Examples of these suggestions include code modifications, configuration changes, or additional diagnostic tests. For instance, if the reasoning paths include an action to add a null-check in a function, the neural language model can generate a code snippet for the developer to integrate.

The neural language model can also provide higher-level guidance based on patterns it identifies in the XML representation 670. By analyzing the parent-child relationships and evaluation results, the model can prioritize debugging strategies that have historically been effective in resolving similar issues. For example, if the evaluations in a reasoning path indicate partial success, the neural language model can suggest complementary actions that address the unresolved aspects of the bug. Conversely, if evaluations identify unsuccessful attempts, the neural language model can guide the developer to avoid repeating those approaches.

In addition to generating recommendations, the neural language model can annotate its suggestions with contextual explanations derived from the reasoning paths. These explanations can include references to observations or actions in the XML representation 670 that informed the suggestion, providing transparency and aiding the developer's decision-making. For example, a model explanation can be, “The generated code patch adds a null-check to the function getCompilationStrategyHint, addressing a failure due to an unregistered service provider, as indicated in the evaluation of a similar debugging case.”

The XML representation 670 also supports interactive debugging workflows. Developers can query specific aspects of the reasoning paths, such as exploring alternative actions or understanding why a particular node was included in the reconstructed tree. The neural language model can dynamically process these queries, leveraging the hierarchical structure of the XML representation 670 to provide detailed responses.

### Example 4—Training and Predicting Actions With Neural Language Models

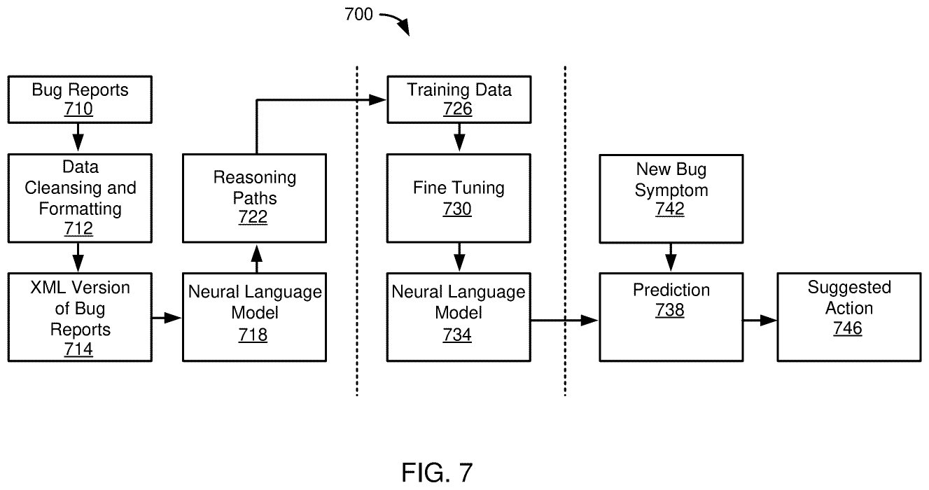

FIG. 7 illustrates a process 700 where a bug report is processed to extract reasoning paths, and a fine-tuned neural language model, such as a neural language model, is used to predict and suggest actions for a new bug symptom. The process 700 uses an approach where the neural language model is used at two stages: first, to extract reasoning paths from historical bug reports, and second, to generate predictions based on new input. Unlike the process involving vector search and retrieval, this approach uses the fine-tuned neural language model to internalize and synthesize historical debugging knowledge.

The process 700 begins with the ingestion of raw bug reports 710, which are pre-processed and converted at 712 into a structured XML representation at 714. This XML data serves as input to the neural language model 718, which is prompted to extract structured reasoning paths 722. Reasoning paths 722 are represented as sequences of observations, thoughts, actions, and evaluations, capturing the logical flow of debugging efforts. The extracted reasoning paths 722 form training data 726 used to fine-tune a neural language model 734, at 730, that provides predictions 738.

Fine-tuning involves adapting a typically pre-trained neural language model to the specific task of reasoning path prediction. The neural language model is initialized with general-purpose pre-training, which provides a broad understanding of natural language and contextual relationships. Fine-tuning narrows its focus, training the model on domain-specific data such as bug reports, reasoning paths, and debugging scenarios. This process typically involves supervised learning, where the model is exposed to pairs of inputs and outputs derived from historical bug data. For example, an input might include a structured representation of a bug symptom, while the corresponding output specifies a reasoning path or suggested action. The model is optimized using loss functions such as cross-entropy, which measures the divergence between the predicted outputs and the ground truth data. Fine-tuning can use techniques such as transfer learning, where the model retains its general language understanding while refining its performance on domain-specific tasks.

To improve the model's ability to generalize, the training dataset can include diverse examples of reasoning paths, covering a wide range of bug types, code bases, and debugging strategies. Data augmentation techniques may also be employed to enrich the training set, such as paraphrasing observations, introducing variations in syntax, or simulating edge cases. Regularization methods, such as dropout or weight decay, are applied during training to prevent overfitting and ensure the model's robustness when applied to new data.

When a new bug symptom 742 is received, the fine-tuned neural language model 734 processes the input text to generate a prediction or suggested action 746. The input text is tokenized into smaller units, such as words or subwords, and embedded into a numerical space using techniques like word embeddings or transformer-based contextual embeddings. The model then uses its learned weights to process the input through its layers, capturing contextual relationships between tokens and generating an output. For example, if the symptom describes a null pointer dereference in a function, the model can associate this with similar patterns seen during training and generate a suggestion to add a null-check or initialize the pointer properly.

The output generation process of the neural language model 734 leverages its internalized knowledge of debugging patterns and relationships learned during fine-tuning. For instance, if the model was trained on reasoning paths involving service registration failures, it can predict actions like modifying initialization scripts, validating configuration files, or checking dependencies. The model also considers contextual clues in the input text, such as the function name, the error message, or the environment where the bug occurred, to tailor its prediction to the specific scenario.

By synthesizing its training data into a cohesive model, the neural language model 734 can generate potential solutions for bug symptoms that do not closely match historical examples. This capability is particularly valuable for addressing complex or unique issues where explicit reasoning paths are not available in the repository. The neural language model 726 can also incorporate broader contextual knowledge from its pre-training, such as general programming practices or domain-specific conventions, to provide more detailed or accurate.

Example 5—Vector Search and Tree Reconstruction for Debugging

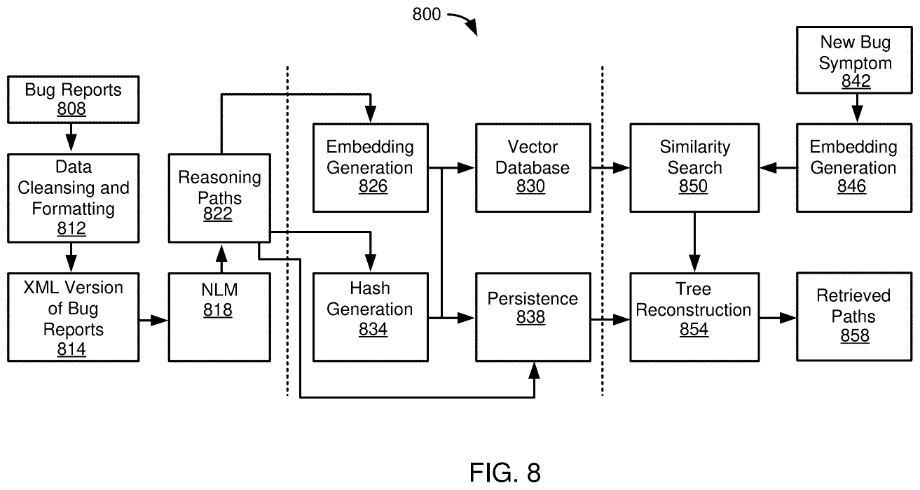

FIG. 8 illustrates a flowchart of a process 800 for processing bug reports, extracting reasoning paths, and retrieving relevant paths for new bug symptoms. The process 800 begins with receiving a raw bug report 808. This bug report 808 includes structured elements, such as metadata, and unstructured elements, for example, developer comments and logs. The report 808 is processed using data cleansing and formatting operations at 812, where irrelevant or noisy information is removed, and the remaining data is organized into a consistent format.

The cleansed and formatted data is transformed into an XML representation 814. This representation 814 structures the information in a machine-readable format. The data in the XML representation 814 is then sent to a neural language model 818, which extracts reasoning paths 822. The reasoning paths 822 are structured into observations, thoughts, actions, and evaluations (OTAE), capturing the logical flow of the debugging process.

The extracted reasoning paths are processed at 826 to generate semantic embeddings. Each observation within a reasoning 822 path is embedded into a high-dimensional vector space, capturing its semantic meaning. These embeddings are stored in a vector database 830, which can be optimized for efficient similarity searches using approximate nearest neighbor techniques. A hash value is generated for each reasoning path 822 at 834. This hash value serves as a unique identifier linking the vector embeddings to the detailed OTAE information associated with the reasoning paths. The hash values, along with the reasoning paths 822, are stored in a persistence layer 838, such as in a relational database management system (RDBMS).

A new bug symptom is received at 842 and is processed at 846 to generate a semantic embedding, which typically uses the same embedding model used at 826. At 850, this embedding is compared against the stored embeddings in the vector database 830 to identify similar observations. The observation hashes corresponding to the matched embeddings are retrieved and used to query the persistence layer 838 for the detailed OTAE information.

A tree reconstruction process is optionally performed at 854 to assemble the retrieved reasoning paths into a coherent hierarchical structure. Starting from the matched nodes in the tree, a specified number of parent and child nodes are identified, reconstructing the logical progression of debugging steps around the matches. The reconstructed tree represents the most relevant portions of historical reasoning paths, tailored to the new bug symptom. This output provides developers with actionable insights, including detailed observations, hypotheses, corrective actions, and evaluations from prior debugging efforts.

In the reconstructed tree, reasoning depth is defined by the number of parent and child nodes included relative to a hit node. Parent depth specifies the hierarchical levels above the hit node, capturing the logical progression of reasoning steps that led to the matched observation. Child depth specifies the levels below the hit node, representing subsequent actions, evaluations, and derived observations. This hierarchical structure allows developers to trace both the context leading to the matched reasoning path and the actions taken afterward.

Reasoning depth can further incorporate relevance criteria to ensure that the reconstructed tree remains focused and actionable. For example, child nodes can be included or excluded based not only on their depth but also on their connection to the debugging process. Nodes that represent abandoned or incomplete paths can be omitted, even if they fall within the allowable depth range.

Retrieved paths 858 from the similarity search 850, and optionally organized into a tree via the tree reconstruction operations at 854, are returned. These paths can optionally be processed as previously described, such as providing them to a neural language model that can analyze the path information and generate solutions for addressing a current bug, and can generate a natural language response describing a process for addressing the bug or generating a suggested path to address the bug.

### Example 6—Hierarchical Tree Construction and Retrieval With Raptor

RAPTOR (Recursive Abstractive Processing for Tree-Organized Retrieval) provides a method for organizing and retrieving debugging knowledge by constructing hierarchical representations of reasoning paths. This technique abstracts and summarizes granular data into layers of increasingly generalized information, forming a structure referred to as a RAPTOR tree. The RAPTOR tree improves storage and multi-level retrieval of debugging insights, and supports reasoning that uses fine-grained details or broader contextual overviews.

The RAPTOR process begins with raw data, such as bug reports or developer comments, which is segmented into smaller textual units. Each unit is embedded into a high-dimensional vector space using models capable of capturing semantic meaning. These embeddings are grouped into clusters based on their similarity, forming the leaf layer of the RAPTOR tree. Each cluster represents closely related data, such as reasoning paths addressing similar debugging scenarios, such as service initialization errors or memory allocation issues. The formation of subsequent layers involves summarizing these clusters using large language models. For example, clusters of leaf nodes are abstracted into intermediate-layer nodes, which themselves are recursively summarized to create the root layer. This recursive clustering and summarization process continues until a single root node is formed, providing a global summary of the underlying data.

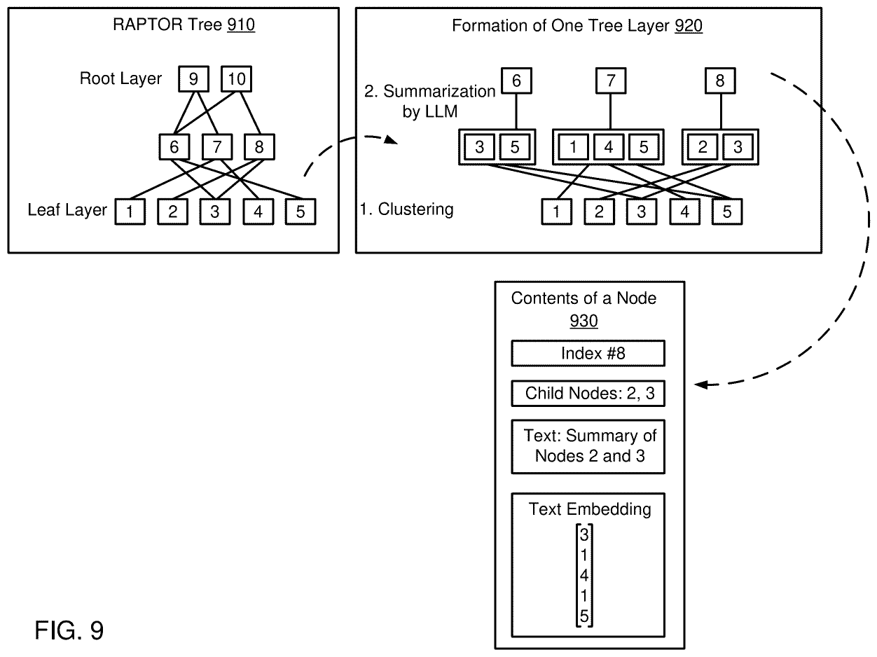

In FIG. 9, the RAPTOR tree structure 910 illustrates the hierarchical organization of reasoning paths. The tree structure 910 includes a root layer, an intermediate layer, and a leaf layer. The root layer has two nodes, each summarizing the contents of its associated intermediate-layer nodes, which may include aggregated insights from similar debugging patterns or cross-module issues. The intermediate layer contains three nodes, each summarizing related clusters of leaf nodes. The leaf layer contains five nodes, representing the most granular data in the hierarchy.

FIG. 9 also illustrates a process 920 of how leaf node information can be summarized in generating the raptor tree 910. The process 920 begins with clustering, where embeddings from the leaf nodes are grouped based on semantic similarity. Each cluster is then summarized by a neural language model, which generates abstractive representations of the clustered data. These summaries form the intermediate-layer nodes. The process 920 is repeated recursively, with intermediate-layer nodes further clustered and summarized to create the root-layer nodes.

FIG. 9 also illustrates example node contents 930. Each node of the RAPTOR tree is uniquely identified by an index, which allows for efficient referencing and retrieval. The node contents 930 also include information identifying its child nodes, allowing the hierarchical structure of the tree to be traversed dynamically. Additionally, the node contents 930 include a text summary, which abstracts and represents the collective meaning of its child nodes, providing insight into the patterns and relationships captured at that level of the hierarchy. The node contents 930 also store a text embedding that encapsulates its semantic meaning in a numerical form, allowing for clustering, retrieval, and similarity searches.

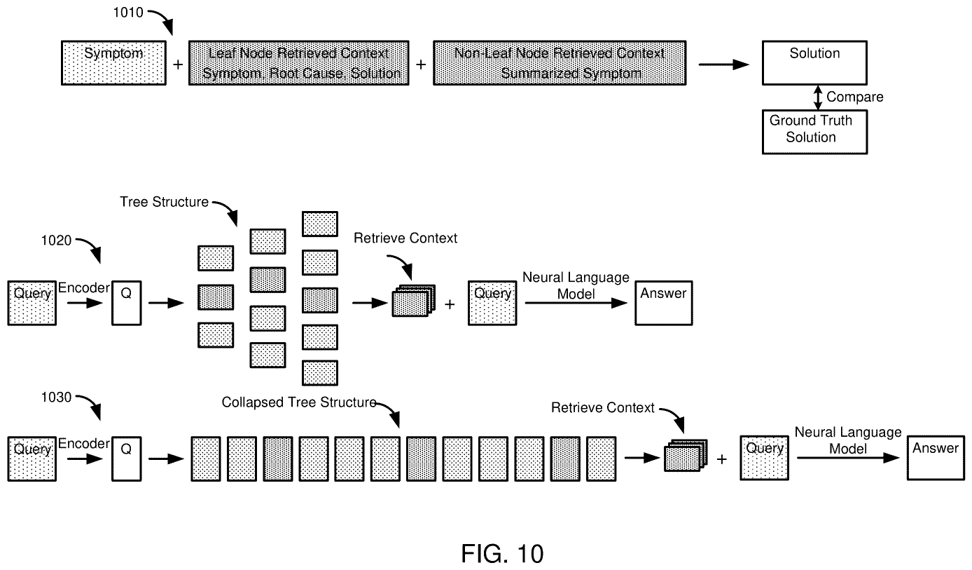

FIG. 10 illustrates the use of a RAPTOR tree, such as the RAPTOR tree 910 of FIG. 9, for retrieving relevant debugging context and combining it with a query to generate solutions. An overall process 1010 of using the RAPTOR tree is illustrated. A query, in the form of a bug symptom, is combined with retrieved context to generate a solution. The context includes both granular information retrieved from leaf nodes of the RAPTOR tree, such as specific symptoms, root causes, and solutions, and higher-level summarized context from non-leaf nodes. The combination of granular and abstracted allows for a solution to be generated that is comprehensive and contextually relevant. Particularly during training, solution can be compared with ground truth to validate its accuracy and ensure its effectiveness in addressing the identified bug.

A process 1020 tree traversal retrieval to generate an answer is illustrated, where the RAPTOR tree is queried to retrieve relevant context for the provided query. The query is encoded into a representation, labeled as Q, using an embedding process. This encoded query is used to traverse the tree structure and identify nodes that are most relevant to the query. Relevant nodes, which may include both leaf nodes and non-leaf nodes, are returned as the retrieved context. This retrieved context is then combined with the query and provided to a neural language model, which generates an answer or solution.

FIG. 10 also illustrates an alternative context retrieval process 1030, referred to as collapsed tree retrieval. In this approach, the hierarchical structure of the RAPTOR tree is partially flattened to optimize retrieval by reducing the need for dynamic traversal. Instead of dynamically traversing parent and child relationships across multiple layers of the tree, the method 1030 treats certain levels of the hierarchy as pre-collapsed or aggregated, where intermediate-layer nodes and their associated child nodes are represented at the same level. This approach eliminates the need to navigate hierarchical connections during retrieval, simplifying the process and enabling faster identification of relevant context, which is particularly beneficial in high-pressure debugging scenarios requiring rapid turnaround.

The collapsed tree structure focuses on efficiency by retaining key information from the original hierarchy while abstracting away some of the detailed relationships between nodes. The retrieved context, derived from the collapsed representation, contains both summarized information and selected granular details that remain pertinent to the query. By treating the flattened structure as a single-level representation, the system bypasses the computational overhead of hierarchical traversal while still leveraging the semantic relevance encoded within the nodes.

Once the relevant context is retrieved from the collapsed structure, it is combined with the query and provided to the neural language model for generating a response. This process is similar to the integration of query and context seen in the tree traversal retrieval method but achieves faster performance due to the simplified retrieval step. Collapsed tree retrieval is particularly advantageous in scenarios where speed or reduction of computational lode is an important factor, or when the level of detail provided by dynamic traversal is not required to address the task effectively.

### Example 7—Code Patch Generation Using Reasoning Paths and Historical Data

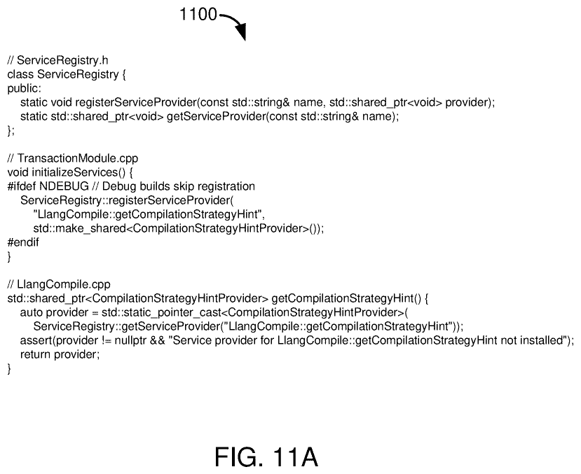

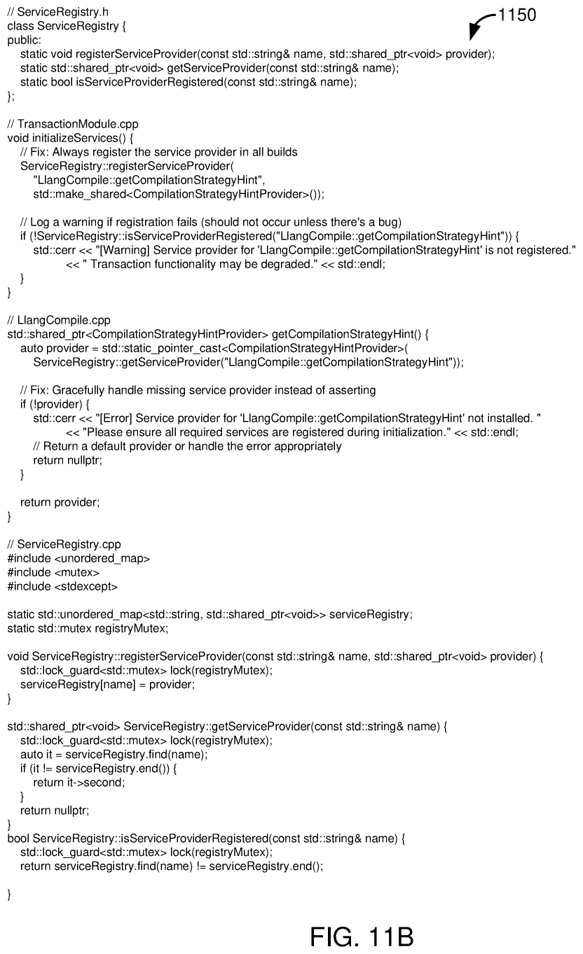

In some implementations, disclosed techniques can be used to automatically generate specific code modifications, producing actionable patches directly from the identified reasoning paths. Before-and-after code examples, such as those illustrated in the code 1100 of FIG. 11A and the code 1150 of FIG. 11B, can be used for both the training process and the retrieval of relevant solutions during debugging. A bug report is analyzed to extract reasoning paths as previously described, including the observed symptoms, identified root cause, and suggested actions. In scenarios involving code-level fixes, the reasoning paths are linked to corresponding source code changes. These changes are represented as before-and-after pairs, as shown in FIGS. 11A and 11B. Code 1110 for the before state, in FIG. 11A, represents code prior to applying a fix, which includes skipped service registration in debug builds and a lack of error handling for missing service providers. In contrast, the after state code 1120 in FIG. 11B demonstrates the corrected code, where service registration is consistently performed, null-checks are added, and error handling is improved. These pairs provide the system with concrete examples of how similar issues were resolved in the past.

During training, a neural language model can be fine-tuned using this annotated dataset. The dataset includes not only the before-and-after code pairs but also the associated reasoning paths that contextualize the changes. Observations, thoughts, and evaluations are incorporated to allow the neural language model to understand the relationships between the problem, the code, and the solution. Success or failure metadata for each fix can be included, allowing the model to prioritize patterns associated with effective solutions.

To facilitate efficient retrieval, before-and-after code examples can be embedded into a high-dimensional vector space. The embeddings are generated using code-specific transformer models, which capture the semantic structure and functionality of the code. These embeddings are stored in a vector database, allowing processes to match new bug contexts with historical examples.

When a new bug is encountered, the description is processed and a semantic embedding representing the context is generated. This embedding is compared against the vector database to retrieve before-and-after code pairs that address similar issues. If a match is found, the system uses the retrieved examples, such as those in FIGS. 11A and 11B, to propose a code fix tailored to the new bug. In cases where no exact match exists, the fine-tuned neural language model can generate a new patch by synthesizing the reasoning path and learned patterns into a plausible solution.

For both the vector search and fine-tuned neural language model approaches, the original code associated with the current bug is provided as part of the input. A prompt can be constructed that includes the reasoning path associated with the current bug, the original source code affected by the bug, and an instruction directing the neural language model to generate a corresponding patch. For example, the prompt may specify that the generated patch should address the identified root cause, conform to best coding practices, and preserve existing functionality. As a specific example, if a reasoning path indicates an issue with a null pointer dereference, disclosed techniques generate a patch that adds a null-check or ensures proper initialization of the pointer, informed by similar historical fixes.

In the vector search approach, the reasoning paths and retrieved before-and-after code examples similar to those in FIG. 11A can be provided in the prompt, where a response includes patched code similar to FIG. 11B. In contrast, in the fine-tuned neural language model approach, a patch can be generated without relying on retrieved before-and-after code pairs but instead by synthesizing a solution directly from the reasoning path, the original code, and its learned debugging patterns.

The generated patch can be validated using automated testing frameworks. Validation includes compiling the modified code, executing test cases, and analyzing system logs to verify that the patch resolves the bug without introducing regressions, ensuring that new issues are not inadvertently introduced into the system. Results from the validation are incorporated back into the system to update the reasoning paths and refine the training dataset of the neural language model.

### Example 8—Additional Features and Feedback Mechanisms

Disclosed techniques can include additional features. One such feature is a feedback loop for continuous learning, which allows disclosed techniques to refine predictions and reasoning paths over time. Outcomes from executed actions, whether successful or not, are fed back into the system, enabling iterative refinement that improves the system's ability to predict and resolve future bugs. For example, when a suggested action resolves a bug, the associated reasoning path can be updated with the new evaluation data, reinforcing the effectiveness of the action. Conversely, when an action fails or produces incomplete results, the system uses this information to refine its understanding of the debugging process, either by adjusting the corresponding reasoning path or by identifying gaps in the training dataset. This iterative learning process helps the system evolve alongside the software it supports.

Disclosed techniques can also include parallel execution of multiple solution paths. This capability is particularly useful when the root cause of a bug is unclear or when there are multiple plausible solutions. Each solution path can be executed in an isolated environment, such as a containerized or virtualized test instance, allowing the process 800 to evaluate the outcomes independently without interference.

Another feature that can be incorporated into the process 800 is the integration of an executor neural language model, which interprets suggested actions and automates their execution. Once the fine-tuned neural language model generates a reasoning path and predicts an appropriate action, the executor neural language model translates the action into specific commands, such as modifying source code, updating configuration files, or initiating diagnostic tests. For instance, if a suggested action involves adding a null-check to a function, the executor neural language model generates the corresponding code snippet and integrates it into the relevant file.

To evaluate the outcomes of executed actions, disclosed techniques can use a variety of automated techniques. These include log analysis, where system logs are scanned for errors, warnings, or other indicators of success; test execution, where predefined test cases are run to confirm that the action resolves the issue without introducing regressions; and error message matching, where observed symptoms are compared against known patterns to determine whether the root cause has been addressed. The evaluation data generated by these techniques can be used to update the reasoning paths and improve predictive capabilities.

### Example 9—Example Operations

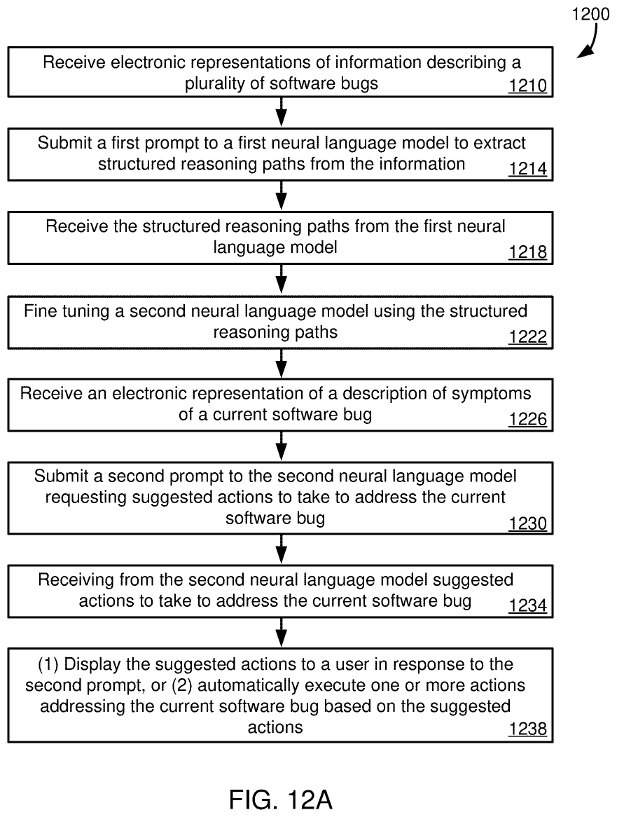

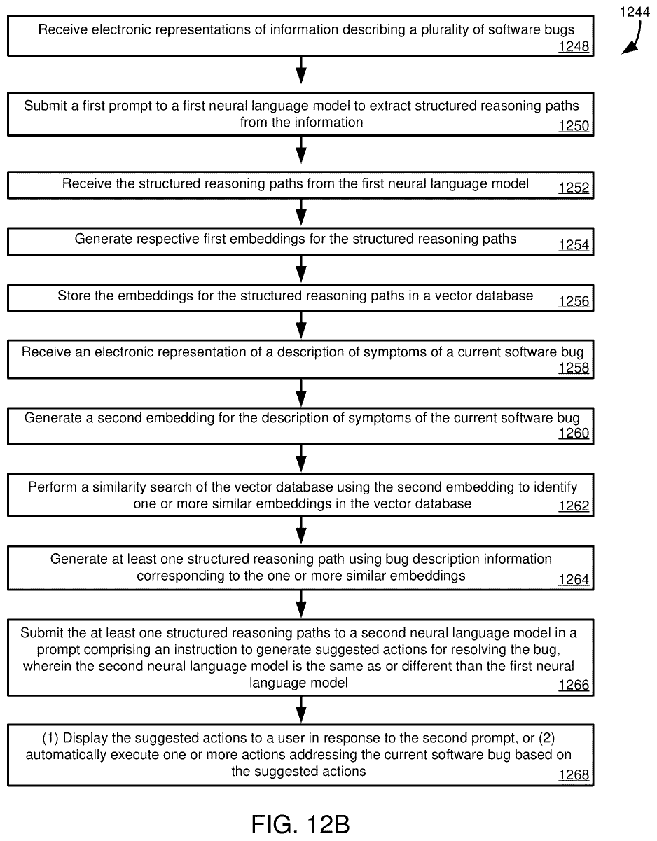

FIG. 12A illustrates a process 1200 for generating debugging solutions using a neural language model.

At 1210, electronic representations of information describing a set of software bugs are received. This information includes comments that document the reasoning process used to develop solutions for respective bugs based on their corresponding descriptions. A first prompt is submitted at 1214 to a first neural language model to extract structured reasoning paths from the received information.

Once processed, the structured reasoning paths are received from the first neural language model at 1218. At 1222, a second neural language model is fine-tuned using the extracted structured reasoning paths. The second neural language model may be the same as or different from the first neural language model.

An electronic representation of a description of symptoms for a current software bug is received at 1226. At 1230, a second prompt is submitted to the second neural language model, requesting suggested actions to address the current software bug.

The second neural language model generates suggestions, which are received at 1234. At 1238, the suggested actions are either displayed to a user or automatically executed to address the current software bug, depending on the implementation.

FIG. 12B illustrates a process 1244 for identifying and applying debugging solutions using a neural language model and a vector database. At 1248, electronic representations of information describing a set of software bugs are received. This information includes respective comments detailing reasoning processes used to develop solutions for the corresponding bugs.

A first prompt is submitted at 1250 to a first neural language model, extracting structured reasoning paths from the received information. The structured reasoning paths are received at 1252 from the first neural language model. At 1254, first embeddings are generated for the extracted structured reasoning paths. The generated embeddings are stored at 1256 in a vector database.

At 1258, an electronic representation of a description of symptoms for a current software bug is received. A second embedding is generated at 1260 for the description of symptoms of the current software bug. At 1262, a similarity search is performed within the vector database using the second embedding to identify one or more similar embeddings.

At 1264, at least one structured reasoning path is generated. At 1266, the structured reasoning path is submitted to a second neural language model in a prompt that includes an instruction to generate suggested actions for addressing the current software bug. The second neural language model may be the same as or different from the first neural language model. At 1268, the neural language model either provides suggested actions for addressing the current software bug or automatically executes one or more actions to resolve the issue based on the suggested actions.

### Example 10—Additional Examples

Example 1 is a computing system that includes at least one memory, one or more hardware processor units coupled to the at least one memory, and one or more computer-readable storage media storing computer-executable instructions. When executed, the instructions cause the computing system to perform operations that include receiving electronic representations of information describing a plurality of software bugs. The information includes respective comments describing a reasoning process for developing a solution for a respective bug of the plurality from a corresponding bug description of the respective bugs.

A first prompt is submitted to a first neural language model to extract structured reasoning paths from the information. The structured reasoning paths are received from the first neural language model. A second neural language model is fine-tuned using the structured reasoning paths. The second neural language model is the same as or different from the first neural language model.

An electronic representation of a description of symptoms of a current software bug is received. A second prompt is submitted to the second neural language model, requesting suggested actions to take to address the current software bug. Suggested actions for addressing the current software bug are received from the second neural language model. The suggested actions are either displayed to a user in response to the second prompt or used to automatically execute one or more actions addressing the current software bug.

Example 2 is the computing system of Example 1, including structured reasoning paths that include an attribute comprising an observation for the respective software bug, an attribute comprising a thought associated with the observation for the respective software bug, an attribute comprising an action implementing the thought for the respective software bug, and an attribute comprising an evaluation of the effect of the action on the respective software bug.

Example 3 is the computing system of Example 1 or Example 2, including a second neural language model that is fine-tuned using supervised learning on annotated debugging datasets. The training data includes before-and-after code snippets linked to structured reasoning paths.

Example 4 is the computing system of any of Examples 1-3, where the at least one of the one or more suggested actions includes a code patch to address the current software bug.

Example 5 is the computing system of any of Examples 1-4, including operations that further include converting electronic representations of information describing a plurality of software bugs to a semi-structured format. The information in the semi-structured format is submitted to the first neural language model.

Example 6 is the computing system of any of Examples 1-5, wherein the first neural language model identifies relationships between the extracted structured reasoning paths. The identified relationships include one or more of hierarchical relationships, causal dependencies, or semantic similarities.

Example 7 is the computing system of Example 1, where the first neural language model generates new structured reasoning paths by synthesizing information from the extracted structured reasoning paths.

Example 8 is a method the is implemented in a computing system that includes at least one memory and one or more hardware processor units coupled to the at least one memory. The method includes receiving electronic representations of information describing a plurality of software bugs. The information includes respective comments describing a reasoning process for developing a solution for a respective bug of the plurality from a corresponding bug description of the respective bugs.

A first prompt is submitted to a first neural language model to extract structured reasoning paths from the information. The structured reasoning paths are received from the first neural language model. Respective first embeddings are generated for the structured reasoning paths. The embeddings for the structured reasoning paths are stored in a vector database.

An electronic representation of a description of symptoms of a current software bug is received. A second embedding is generated for the description of symptoms of the current software bug. A similarity search of the vector database is performed using the second embedding to identify one or more similar embeddings in the vector database. At least one structured reasoning path is generated using bug description information corresponding to the one or more similar embeddings.

The at least one structured reasoning path is submitted to a second neural language model in a prompt comprising an instruction to generate suggested actions for addressing the current software bug or automatically executing one or more actions addressing the current software bug based on the suggested actions. The second neural language model is the same as or different from the first neural language model.

Example 9 is the method of Example 8, including structured reasoning paths that include an attribute comprising an observation for the respective software bug, an attribute comprising a thought associated with the observation for the respective software bug, an attribute comprising an action implementing the thought for the respective software bug, and an attribute comprising an evaluation of the effect of the action on the respective software bug.

Example 10 is the method of Example 9, including storing the structured reasoning paths, including attributes comprising observations, thoughts, actions, and evaluations, in a relational database. Each structured reasoning path is associated with its respective hash value in the relational database.

Example 11 is the method of any of Examples 8-10, where the at least one of the one or more suggested actions includes a code patch to address the current software bug.

Example 12 is the method of any of Examples 8-11, including converting electronic representations of information describing a plurality of software bugs to a semi-structured format. The information in the semi-structured format is submitted to the first neural language model.

Example 13 is the method of any of Examples 8-12, including generating respective hash values for the structured reasoning paths extracted by the first neural language model. The respective hash values are stored in association with corresponding structured reasoning paths. In response to identifying one or more similar embeddings in the vector database, the respective reasoning paths corresponding to the similar embeddings are retrieved using the associated hash values.

Example 14 is the method of any of Examples 8-13, including identifying relationships between the structured reasoning paths generated by the first neural language model. The identified relationships include one or more of hierarchical relationships, causal dependencies, or semantic similarities.

Example 15 is the method of Example 14, including generating at least one structured reasoning path by identifying reasoning paths that include a plurality of nodes. Each node includes a structured reasoning path, and relationships between the plurality of nodes are defined by one or more of hierarchical relationships, causal dependencies, or semantic similarities.

Example 16 is the method of Example 15, including identifying reasoning paths that include a plurality of nodes and limiting the identification to nodes within a specified parent depth or child depth relative to a selected node. The parent depth specifies a maximum number of hierarchical levels above the selected node, and the child depth specifies a maximum number of hierarchical levels below the selected node.

Example 17 is the method of any of Examples 8-16, including generating new structured reasoning paths by synthesizing information from the structured reasoning paths generated by the first neural language model.

Example 18 is the method of any of Examples 8-17, including performing tree reconstruction during query processing by expanding a portion of a hierarchical structure of reasoning paths. The tree reconstruction includes identifying nodes in the hierarchical structure related to a selected node based on semantic similarity, causal relationships, or hierarchical depth limits. The reconstructed tree or its collapsed representation is combined with query data to refine context for generating the suggested actions.

Example 19 is the method of any of Examples 8-18, including generating the respective first embeddings for the structured reasoning paths by summarizing information in one or more structured reasoning paths into a vector representation. The summarization abstracts details of observations, thoughts, actions, and evaluations while retaining semantic relationships between them. The summarization includes combining information from multiple nodes to generate a new node representing an aggregated reasoning path. The vector representations are used for similarity searches and for contextual responses provided by the second neural language model.

### Example 11—Computing Systems

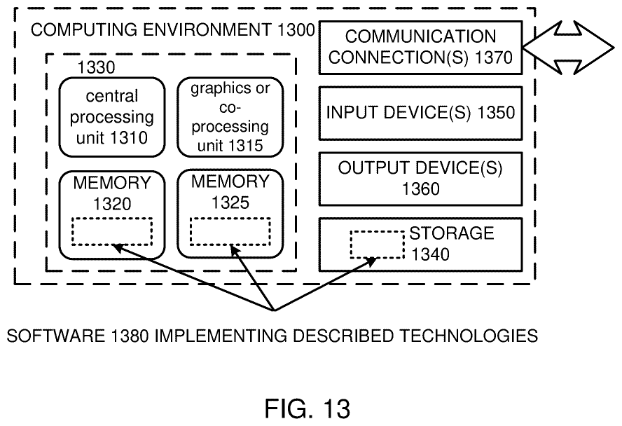

FIG. 13 depicts a generalized example of a suitable computing system 1300 in which the described innovations may be implemented. The computing system 1300 is not intended to suggest any limitation as to scope of use or functionality of the present disclosure, as the innovations may be implemented in diverse general-purpose or special-purpose computing systems.

With reference to FIG. 13, the computing system 1300 includes one or more processing units 1310, 1315 and memory 1320, 1325. In FIG. 13, this basic configuration 1330 is included within a dashed line. The processing units 1310, 1315 execute computer-executable instructions, such as for implementing a database environment, and associated methods, described in Examples 1-8. A processing unit can be a general-purpose central processing unit (CPU), a processor in an application-specific integrated circuit (ASIC), or any other type of processor. In a multi-processing system, multiple processing units execute computer-executable instructions to increase processing power. For example, FIG. 13 shows a central processing unit 1310 as well as a graphics processing unit or co-processing unit 1315. The tangible memory 1320, 1325 may be volatile memory (e.g., registers, cache, RAM), non-volatile memory (e.g., ROM, EEPROM, flash memory, etc.), or some combination of the two, accessible by the processing unit(s) 1310, 1315. The memory 1320, 1325 stores software 1380 implementing one or more innovations described herein, in the form of computer-executable instructions suitable for execution by the processing unit(s) 1310, 1315.

A computing system 1300 may have additional features. For example, the computing system 1300 includes storage 1340, one or more input devices 1350, one or more output devices 1360, and one or more communication connections 1370. An interconnection mechanism (not shown) such as a bus, controller, or network interconnects the components of the computing system 1300. Typically, operating system software (not shown) provides an operating environment for other software executing in the computing system 1300, and coordinates activities of the components of the computing system 1300.

The tangible storage 1340 may be removable or non-removable, and includes magnetic disks, magnetic tapes or cassettes, CD-ROMs, DVDs, or any other medium which can be used to store information in a non-transitory way, and which can be accessed within the computing system 1300. The storage 1340 stores instructions for the software 1380 implementing one or more innovations described herein.

The input device(s) 1350 may be a touch input device such as a keyboard, mouse, pen, or trackball, a voice input device, a scanning device, or another device that provides input to the computing system 1300. The output device(s) 1360 may be a display, printer, speaker, CD-writer, or another device that provides output from the computing system 1300.

The communication connection(s) 1370 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 12—Cloud Computing Environment

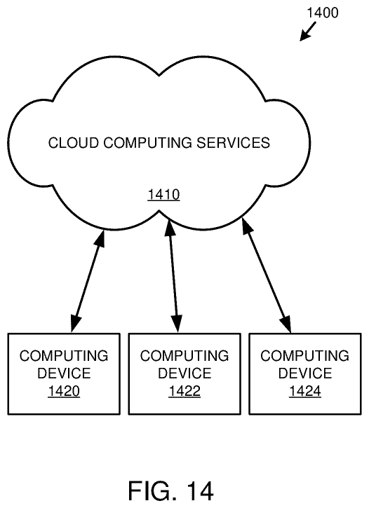

FIG. 14 depicts an example cloud computing environment 1400 in which the described technologies can be implemented. The cloud computing environment 1400 comprises cloud computing services 1410. The cloud computing services 1410 can comprise various types of cloud computing resources, such as computer servers, data storage repositories, networking resources, etc. The cloud computing services 1410 can be centrally located (e.g., provided by a data center of a business or organization) or distributed (e.g., provided by various computing resources located at different locations, such as different data centers and/or located in different cities or countries). The cloud computing services 1410 are utilized by various types of computing devices (e.g., client computing devices), such as computing devices 1420, 1422, and 1424. For example, the computing devices (e.g., 1420, 1422, and 1424) can be computers (e.g., desktop or laptop computers), mobile devices (e.g., tablet computers or smart phones), or other types of computing devices. For example, the computing devices (e.g., 1420, 1422, and 1424) can utilize the cloud computing services 1410 to perform computing operators (e.g., data processing, data storage, and the like).

### Example 13—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 13, computer-readable storage media include memory 1320 and 1325, and storage 1340. The term computer-readable storage media does not include signals and carrier waves. In addition, the term computer-readable storage media does not include communication connections (e.g., 1370).

Any of the computer-executable instructions for implementing the disclosed techniques, as well as any data created and used during implementation of the disclosed embodiments, can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, Structured Query Language, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one memory;
one or more hardware processor units coupled to the at least one memory; and
one or more computer readable storage media storing computer-executable instructions that, when executed, cause the computing system to perform operations comprising:
receiving electronic representations of information describing a plurality of software bugs, the information comprising respective comments describing a reasoning process for developing a solution for a respective bug of the plurality from a corresponding bug description of the respective bugs;
submitting a first prompt to a first neural language model to extract structured reasoning paths from the information;
receiving the structured reasoning paths from the first neural language model;
fine tuning a second neural language model using the structured reasoning paths, wherein the second neural language model is the same as or different than the first neural language model;
receiving an electronic representation of a description of symptoms of a current software bug;
submitting a second prompt to the second neural language model requesting suggested actions to take to address the current software bug;
receiving, from the second neural language model, one or more suggested actions to take to address the current software bug; and
(1) displaying at least one of the one or more suggested actions to a user in response to the second prompt; or
(2) automatically executing one or more actions addressing the current software bug based on at least one of the one or more suggested actions.

2. The computing system of claim 1, wherein the structured reasoning paths comprise:
(1) an attribute comprising an observation for the respective software bug;
(2) an attribute comprising a thought associated with the observation for the respective software bug;
(3) an attribute comprising an action implementing the thought for the respective software bug; and
(4) an attribute comprising an evaluation of the effect of the action on the respective software bug.

3. The computing system of claim 1, wherein the second neural language model is fine-tuned using supervised learning on annotated debugging datasets, the training data including before-and-after code snippets linked to structured reasoning paths.

4. The computing system of claim 1, wherein the at least one of the one or more suggested actions comprises a code patch to address the current software bug.

5. The computing system of claim 1, the operations further comprising:
converting electronic representations of information describing a plurality of software bugs to a semi-structured format, wherein the information in the semi-structured format is submitted to the first neural language model.

6. The computing system of claim 1, wherein the first neural language model identifies relationships between the extracted structured reasoning paths, the relationships comprising one or more of hierarchical relationships, causal dependencies, or semantic similarities.

7. The computing system of claim 1, wherein the first neural language model generates new structured reasoning paths by synthesizing information from the extracted structured reasoning paths.

8. A method, implemented in a computing system comprising at least one memory and one or more hardware processor units coupled to the at least one memory, the method comprising:
receiving electronic representations of information describing a plurality of software bugs, the information comprising respective comments describing a reasoning process for developing a solution for a respective bug of the plurality from a corresponding bug description of the respective bugs;
submitting a first prompt to a first neural language model to extract structured reasoning paths from the information;
receiving the structured reasoning paths from the first neural language model;
generating respective first embeddings for the structured reasoning paths;
storing the embeddings for the structured reasoning paths in a vector database;
receiving an electronic representation of a description of symptoms of a current software bug;
generating a second embedding for the description of symptoms of the current software bug;
performing a similarity search of the vector database using the second embedding to identify one or more similar embeddings in the vector database;
generating at least one structured reasoning path using bug description information corresponding to the one or more similar embeddings;
submitting the at least one structured reasoning paths to a second neural language model in a prompt comprising an instruction to generate one or more suggested actions for addressing the current software bug, wherein the second neural language model is the same as or different than the first neural language model; and
(1) displaying at least one of the one or more suggested actions for addressing the current software bug; or
(2) automatically executing one or more actions addressing the current software bug based on at least one of the one or more suggested actions.

9. The method of claim 8, wherein the structured reasoning paths comprise:
(1) an attribute comprising an observation for the respective software bug;
(2) an attribute comprising a thought associated with the observation for the respective software bug;
(3) an attribute comprising an action implementing the thought for the respective software bug; and
(4) an attribute comprising an evaluation of the effect of the action on the respective software bug.

10. The method of claim 9, further comprising:
storing the structured reasoning paths, including attributes comprising observations, thoughts, actions, and evaluations, in a relational database; and
associating each structured reasoning path with its respective hash value in the relational database.

11. The method of claim 8, wherein the at least one of the one or more suggested actions comprises a code patch to address the current software bug.

12. The method of claim 8, further comprising:
converting electronic representations of information describing a plurality of software bugs to a semi-structured format, wherein the information in the semi-structured format is submitted to the first neural language model.

13. The method of claim 8, further comprising:
generating respective hash values for the structured reasoning paths extracted by the first neural language model;
storing the respective hash values in association with corresponding structured reasoning paths; and
in response to identifying one or more similar embeddings in the vector database, retrieving the respective reasoning paths corresponding to the similar embeddings using the associated hash values.

14. The method of claim 8, further comprising:
identifying relationships between the structured reasoning paths generated by the first neural language model, the relationships comprising one or more of hierarchical relationships, causal dependencies, or semantic similarities.

15. The method of claim 14, wherein generating at least one structured reasoning paths comprises identifying reasoning paths that comprise a plurality of nodes, wherein:
each node comprises a structured reasoning path; and
relationships between the plurality of nodes are defined by one or more of the hierarchical relationships, causal dependencies, or semantic similarities.

16. The method of claim 15, wherein identifying reasoning paths that comprise a plurality of nodes further comprises:
limiting the identification to nodes within a specified parent depth or child depth relative to a selected node, wherein:
(1) the parent depth specifies a maximum number of hierarchical levels above the selected node; and
(2) the child depth specifies a maximum number of hierarchical levels below the selected node.

17. The method of claim 8, further comprising:
generating new structured reasoning paths by synthesizing information from the structured reasoning paths generated by the first neural language model.

18. The method of claim 8, further comprising:
performing tree reconstruction during query processing by expanding a portion of a hierarchical structure of reasoning paths, wherein the tree reconstruction comprises:
identifying nodes in the hierarchical structure related to a selected node based on semantic similarity, causal relationships, or hierarchical depth limits; and
combining the reconstructed tree or its collapsed representation with query data to refine context for generating the suggested actions.

19. The method of claim 8, wherein generating the respective first embeddings for the structured reasoning paths comprises:
summarizing information in one or more structured reasoning paths into a vector representation, the summarization abstracting details of observations, thoughts, actions, and evaluations while retaining semantic relationships between them;
wherein the summarization comprises combining information from multiple nodes to generate a new node representing an aggregated reasoning path; and
wherein the vector representations are used for similarity searches and for contextual responses provided by the second neural language model.

20. One or more computer-readable storage media comprising:
computer-executable instructions that, when executed by a computing system comprising at least one hardware processor and at least one memory coupled to the at least on hardware processor, cause the computing system to receive electronic representations of information describing a plurality of software bugs, the information comprising respective comments describing a reasoning process for developing a solution for a respective bug of the plurality from a corresponding bug description of the respective bugs;
computer-executable instructions that, when executed by the computing system, cause the computing system to submit a first prompt to a first neural language model to extract structured reasoning paths from the information;
computer-executable instructions that, when executed by the computing system, cause the computing system to receive the structured reasoning paths from the first neural language model;
computer-executable instructions that, when executed by the computing system, cause the computing system to fine tune a second neural language model using the structured reasoning paths, wherein the second neural language model is the same as or different than the first neural language model;
receiving an electronic representation of a description of symptoms of a current software bug; computer-executable instructions that, when executed by the computing system, cause the computing system to submit a second prompt to the second neural language model requesting suggested actions to take to address the current software bug;
computer-executable instructions that, when executed by the computing system, cause the computing system to receive, from the second neural language model, one or more suggested actions to take to address the current software bug; and
(1) computer-executable instructions that, when executed by the computing system, cause the computing system to display the one or more suggested actions to a user in response to the second prompt; or
(2) computer-executable instructions that, when executed by the computing system, cause the computing system to automatically execute one or more actions addressing the current software bug based on at least one of the one or more suggested actions.
